(19) United States
(12) Patent Application Publication
(10) Pub. No.: US 2012/0252535 A1
(43) Pub. Date: Oct. 4, 2012

(54) ELECTRONIC APPARATUS AND FLEXIBLE SUBSTRATE

(75) Inventors: Yoshifumi KAJIWARA, Kawasaki (JP); Hiroyuki TAKITA, Kawasaki (JP); Takashi SUZUKI, Kawasaki (JP); Kazuhiro TADA, Kawasaki (JP); Hiroshi KUBO, Kawasaki (JP)

(73) Assignee: FUJITSU LIMITED, Kawasaki-shi (JP)

(21) Appl. No.: 13/417,640

(22) Filed: Mar. 12, 2012

(30) Foreign Application Priority Data
Mar. 31, 2011 (JP) 2011-077401

(51) Int. Cl. H04R 1/02; H04W 88/02; H04M 1/02

(52) U.S. Cl. 455/566; 381/369

(57) ABSTRACT

An electronic apparatus includes: a housing having a liquid crystal display section mounted in the housing; a space section formed between an end side in the housing and the liquid crystal display section; and a circuit unit having an antenna pattern, a microphone, and one or plurality of mounting components being mounted on one or both of the front and rear surface sides of the circuit unit arranged in the space section.

### CROSS REFERENCE TO RELATED APPLICATION

This application is based upon and claims the benefit of priority from the prior Japanese Patent Application NO. 2011-077401 filed on Mar. 31, 2011, the entire contents of which are incorporated herein by reference.

### FIELD

The embodiments disclosed hereafter is related to an electronic apparatus having a substrate structure on which mounting components are mounted.

### BACKGROUND

Among portable electronic apparatuses, such as a portable telephone, there is an apparatus which is configured by, for example, a plurality of housings including a housing provided with a display function, and a housing provided with an input operation function, and in which one of the housings is slidably connected to the other housing. Among such portable telephones provided with a plurality of housings, there is a portable telephone in which, in order to enable voice communication without sliding the housing, a microphone is also mounted on the side of the housing provided with the display function.

A portable telephone depicted in FIG. 14 is known, in which, in a housing 202 of a portable telephone 200, for example, a microphone 210 is mounted on a flexible substrate 206 on the lower side of a liquid crystal display section 208 so as to avoid a display function component. The flexible substrate 206 is deformed so as to avoid, for example, a flexible substrate 214, and the like, arranged in the housing 202. In addition, for example, an antenna pattern 212 is formed on the flexible substrate 206.

As for the configuration inside the housing of such electronic apparatus, it is known, for example, that a resin substrate is installed in the display section housing case and that a microphone is mounted on the resin substrate so as to be directed in the direction from the display section housing case to the operation section housing case.

Further, it is known that, in a portable radio terminal apparatus, an antenna conductor is provided and that a reinforcing section for reinforcing the antenna conductor is provided.
[Patent Document 1] Japanese Laid-Open Patent Publication No. 2010-130106
[Patent Document 2] Japanese Laid-Open Patent Publication No. 2003-338769
[Patent Document 3] Japanese Laid-Open Patent Publication No. 2006-345246

Meanwhile, although the portable telephone is multi-functionalized, the size of the housing is reduced from a viewpoint of portability, and the like, so as to limit the space in which components for achieving multiple functions are mounted. In order to mount the functional components in the housing provided with a display function, a substrate is installed on the bottom side of the housing, but the mounting space on the substrate is limited. For this reason, when an antenna pattern, a microphone, and the like, are mounted on the substrate, the other mounting components are difficult to be mounted. Further, it is also difficult to arrange another substrate in the housing.

### SUMMARY

According to an aspect of the embodiments, there is provided an electronic apparatus includes: a housing having a liquid crystal display section mounted in the housing; a space section formed between an end side in the housing and the liquid crystal display section; and a circuit unit having an antenna pattern, a microphone, and one or plurality of mounting components being mounted on one or both of the front and rear surface sides of the circuit unit arranged in the space section.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF THE DRAWINGS

FIG. 1 is a view depicting a configuration example of a portable telephone according to a first embodiment;

FIG. 2 is a view depicting an external configuration example of the portable telephone in the closed state;

FIG. 3 is a view depicting a configuration example of the rear surface side of a substrate section;

FIG. 4 is a view depicting an example of a mounting configuration of a flexible substrate;

FIGS. 5A and 5B are views depicting an example of a folded state of the flexible substrate;

FIGS. 6A and 6B are views depicting an example of a mounting configuration in the state where the flexible substrate is opened;

FIG. 7 is a view depicting an example of conductor wirings in the state where the flexible substrate is opened;

FIG. 8 is a view depicting an installation example of reinforcing members on the flexible substrate;

FIG. 9 is a view depicting a sectional view taken along line A-A in FIG. 4;

FIG. 10 is a view depicting an example of a state where the flexible substrate is mounted on the side of the movable rear case;

FIG. 11 is a view depicting an example of an overlapped state of the flexible substrate and the other components;

FIG. 12 is a view depicting a sectional view taken along line B-B in FIG. 2;

FIG. 13 is a view depicting a configuration example of a flexible substrate according to another embodiment; and

FIG. 14 is a view depicting an example of a conventional flexible substrate for a microphone.

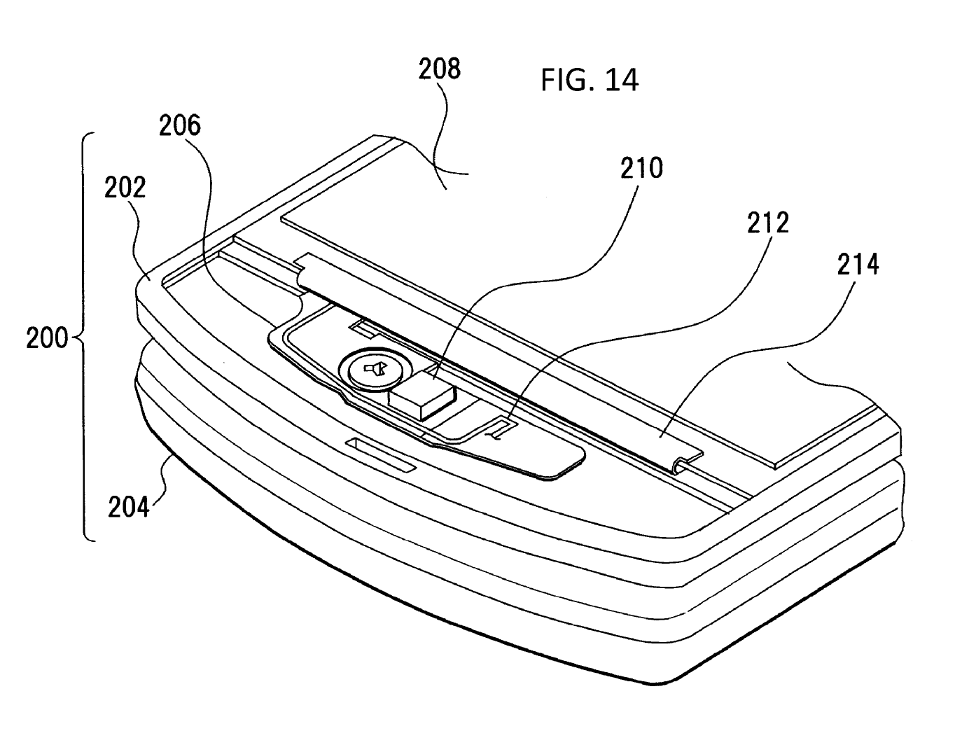

### DESCRIPTION OF EMBODIMENTS

### First Embodiment

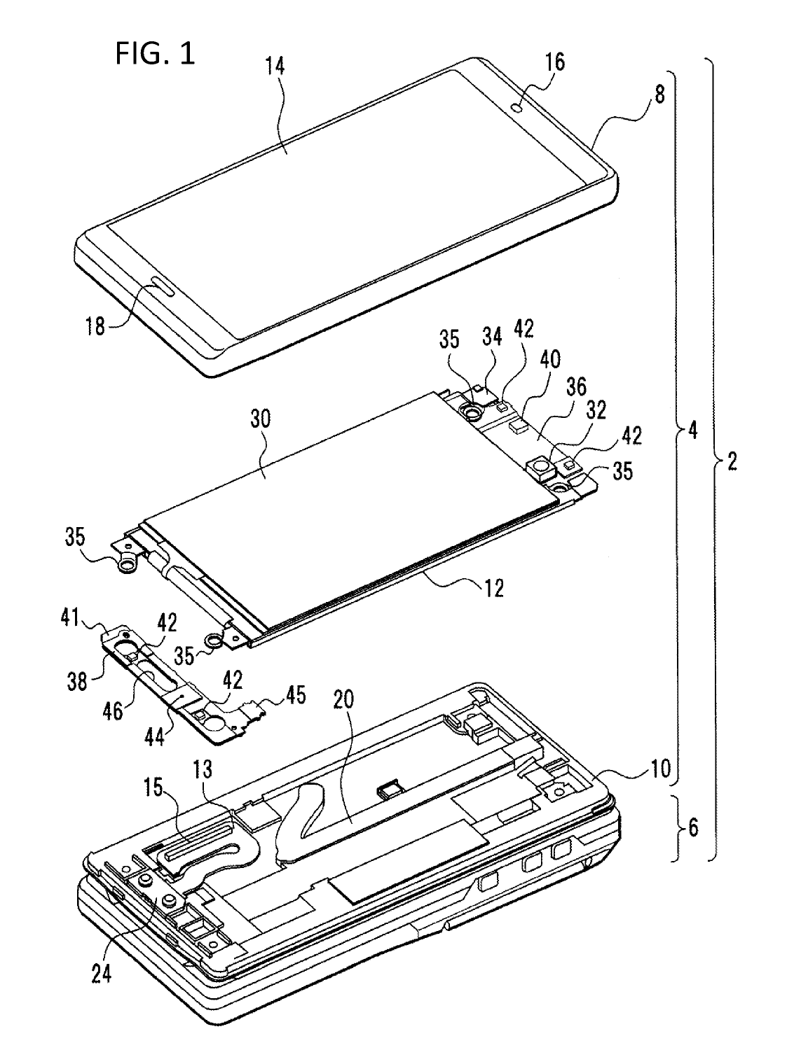

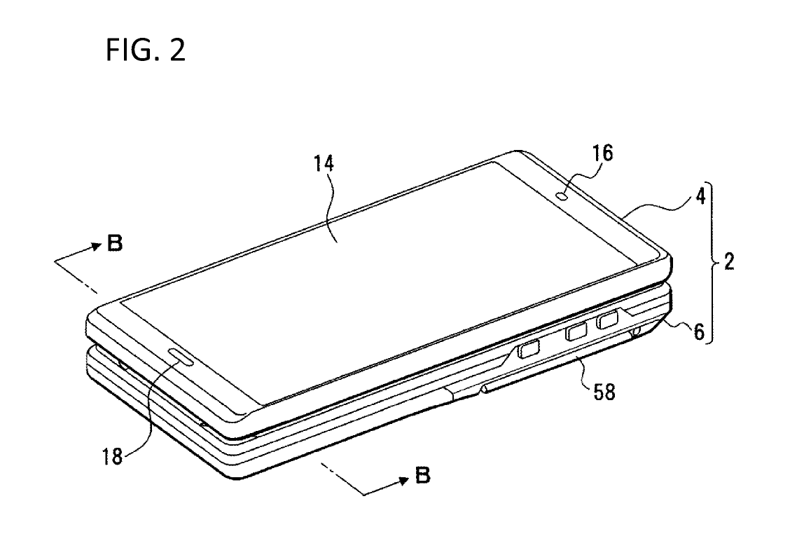

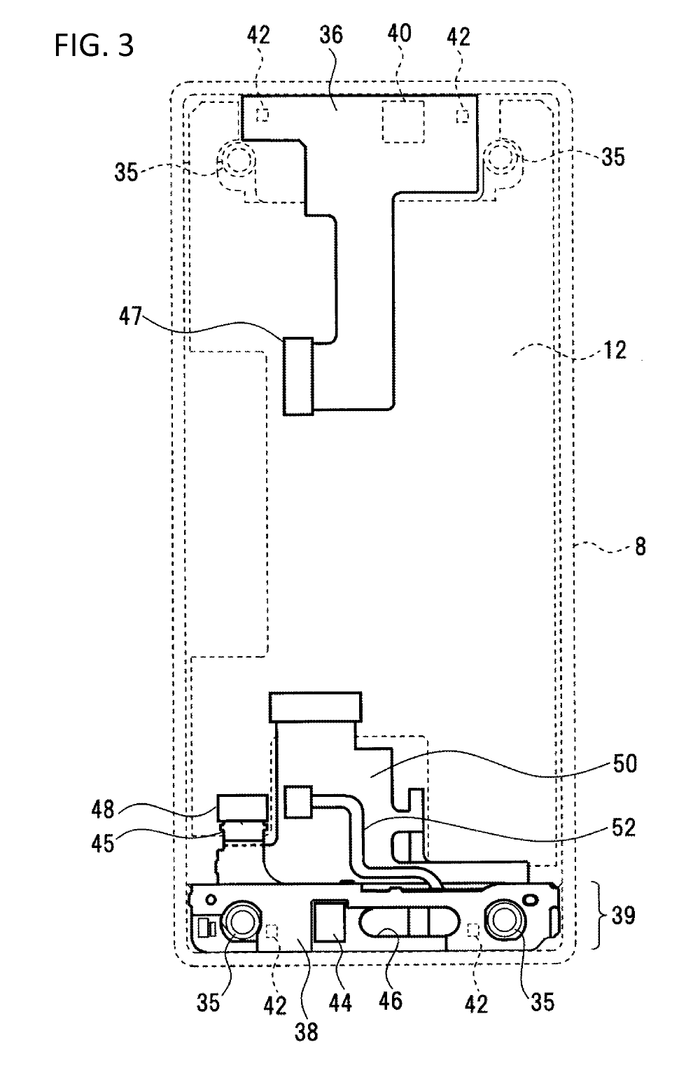

A first embodiment will be described with reference to FIG. 1, FIG. 2 and FIG. 3. FIG. 1 is a view depicting a configuration example of a portable telephone according to a first embodiment. FIG. 2 is a view depicting an external configuration example of the portable telephone in the closed state. FIG. 3 is a view depicting a configuration example of the rear surface side of a substrate section. The configuration depicted in FIG. 1 to FIG. 3 is an example, and the present invention is not limited to this configuration.

A portable telephone 2 is an example of an electronic apparatus disclosed herein and includes, for example, a first housing section 4 and a second housing section 6 so that the housing section 4 is stacked on the housing section 6 so as to be longitudinally slidable with respect to the housing section 6. The housing section 4 mainly configures, for example, a display side housing section, and the housing section 6 mainly configures an operation side housing section.

The housing section 4 is an example of a housing of an electronic apparatus, and configures, for example, a movable side housing section which is slidable with respect to the housing section 6. The housing section 4, which is configured by, for example, a movable front case 8 and a movable rear case 10, incorporates a substrate section 12 between the movable front case 8 and the movable rear case 10. Each of the movable front case 8 and the movable rear case 10 is, for example, a molded body made of a resin material. The housing section 4 is electrically connected to the housing section 6 by a cable 13.

A display window section 14 is formed in the movable front case 8, and a liquid crystal display panel 30 installed on the substrate section 12 is arranged in the display window section 14 so as to perform screen display. Further, for example, a touch panel module may also be arranged in the display window section 14 so as to function as operation input means. Further, for example, a sound emitting hole 16 and a sound absorbing hole 18, which are used for a voice communication function, are respectively formed in the longitudinal front and rear end sections of the movable front case 8. Further, on the inner side of the side surface of the movable front case 8, for example, locking claws, and the like, to be locked to the movable rear case 10 and the substrate section 12 are formed, and a waterproof member for preventing entry of water into the housing section 4 from the outside is installed.

On the movable rear case 10, the substrate section 12 is mounted and held, and the cable 13 inserted into the housing section 4 is arranged so as to correspond to the mounting position of the substrate section 12. For example, a connector 15 is attached to the end of the cable 13, and is connected to a connector (not depicted) installed on the side of the substrate section 12. In the movable rear case 10, a slide guide 20 which enables the housing section 4 to slide with respect to the housing section 6, and a cable insertion hole through which the cable 13 is inserted into the housing section 4, and the like, are formed. A water cut-off component 24 which prevents entry of water, and the like, from the cable insertion hole is installed in the movable rear case 10. The water cut-off component 24 covers the cable insertion hole with the cable 13 inserted therein, and is fixed by, for example, a screw from the rear surface side of the movable rear case 10. The screw is fixing means for fixing the water cut-off component 24 to the movable rear case 10, and is an example of urging means for bringing the water cut-off component 24 into press contact with the movable rear case 10. The means for fixing the water cut-off component 24 is not limited to a screw, and a fixing component using a fastening component, a locking component, and the like, is used as the means for fixing the water cut-off component 24.

The substrate section 12 is an example of a functional configuration section mounted in the movable side housing section 4, and one or a plurality of functional components are mounted on the substrate section 12. On the substrate section 12, for example, the liquid crystal display panel 30, a camera 32, an antenna functional component 34 are mounted. Also, on the substrate section 12, flexible substrates 36 and 38, and the like, are respectively mounted on both longitudinal front and rear sides of the liquid crystal display panel 30. Further, for example, through holes 35 are provided on each longitudinal end side of the substrate section 12. The through hole 35 is an example of means for fixing the substrate section 12 to the movable rear case 10. For example, fixing components, such as screws and bolts, are made to pass through the through holes 35 via the flexible substrates 36 and 38.

The flexible substrate 36 is configured by, for example, a planar flexible wiring conductor, and is an example of a circuit unit or a flexible substrate, which are arranged at the top side of the housing section 4. A loudspeaker 40, which outputs call voice, or the like, and an LED (Light Emitting Diode) element 42, which emits light on the surface side of the portable telephone 2, are mounted on the flexible substrate 36.

The flexible substrate 38 is an example of a circuit unit or a flexible substrate of the housing section 4, and is arranged in a space section 39 (FIG. 3) formed between the internal end section on the bottom side of the housing section 4 and the liquid crystal display panel 30 which is a display section.

Each of the flexible substrates 36 and 38 is formed of, for example, a resin material, and is configured by a planar flexible wiring conductor which can be subjected to deformation such as bending. An antenna 41 is formed on the flexible substrate 38, and further a microphone 44, and the LED element 42, and the like, as the other functional components, are mounted on one or both of the front and rear surface sides of the flexible substrate 38. Further, a connector 45, which is electrically connected to the substrate section 12, is formed on the flexible substrate 38.

For example, the transmission and reception of control instructions to and from the control function section of the portable telephone 2 are performed through the substrate section 12, so that the operation control of the mounting components is performed. Further, an opening section 46 for avoiding contact with the water cut-off component 24 installed in the movable front case 10 is formed in a part of the flexible substrate 38.

As shown in FIG. 2, the portable telephone 2 is configured such that the housing section 4 is stacked on the upper side of the housing section 6, and such that, in the closed state, the upper surface side of the housing section 6 is covered by the housing section 4, so as to prevent contact operation. Even in the closed state of the portable telephone 2, it is possible to utilize, for example, a voice communication function, and browsing functions, and the like, using display functions of Web site, mail, and the like. Further, the portable telephone 2 can also be operated by a touch panel provided in the display window section 14.

In the case where an input operation function is used, for example, when the housing section 4 is made to slide in the longitudinal direction, the upper surface side of the housing section 6 is exposed. The housing section 6 is an example of the operation side housing section of the portable telephone 2, and configures a fixed side housing section, with respect to which the housing section 4 is slid. The housing section 6 is provided with, for example, a keypad in which a ten key, a decision key, a cursor key, and the like, are arranged. Further, for example, an antenna 58, which receives a television broadcasting signal and which transmits and receives a data signal, is provided on the side surface section on the tip side of the housing section 6.

Further, for example, a connector 47 connected to the flexible substrate 36, and a connector 48 connected to the connector 45 of the flexible substrate 38 are installed on the rear surface side of the substrate section 12 depicted in FIG. 3. Further, flexible cables 50 and 52, and the like, which are connected to the liquid crystal display panel 30 arranged on the front surface side, the touch panel (not depicted), and the like, are installed on the substrate section 12, and are arranged in the vicinity of or to vertically overlap with the flexible substrate 38 in the direction toward the front surface side of the substrate section 12.

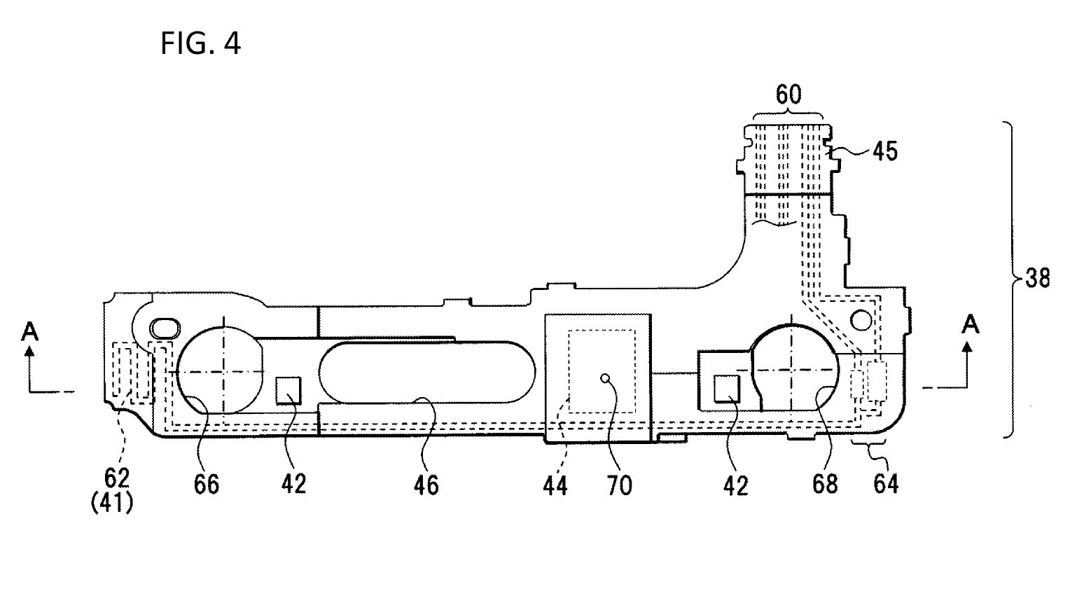

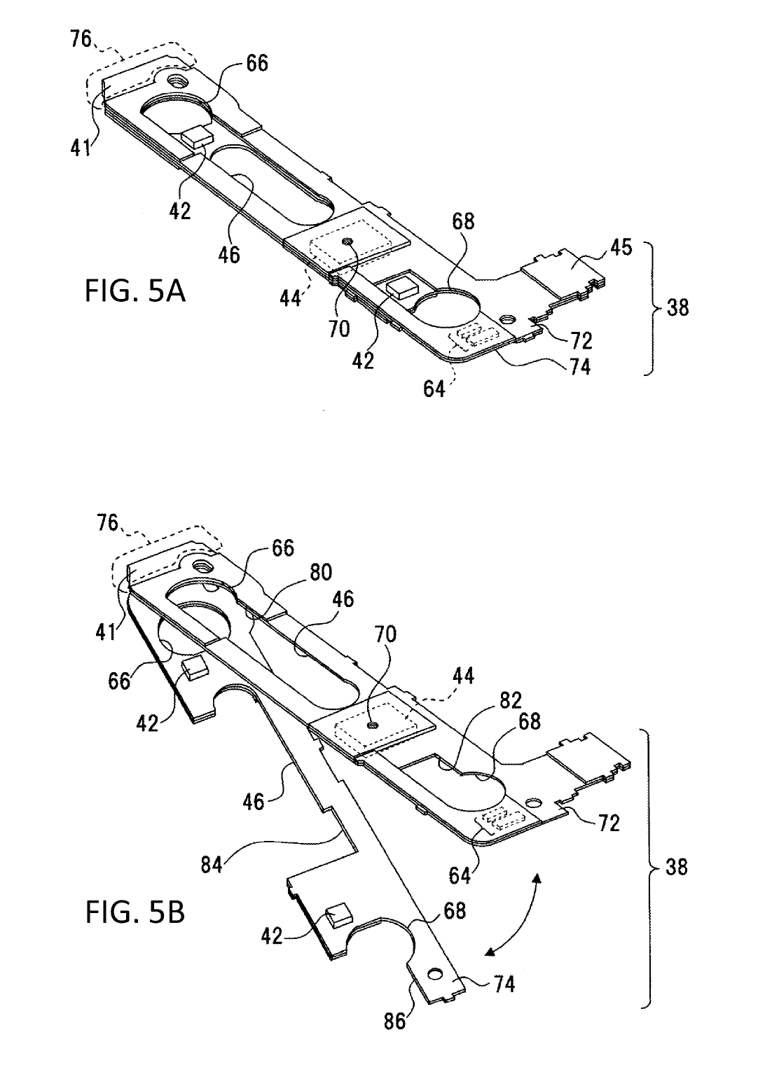

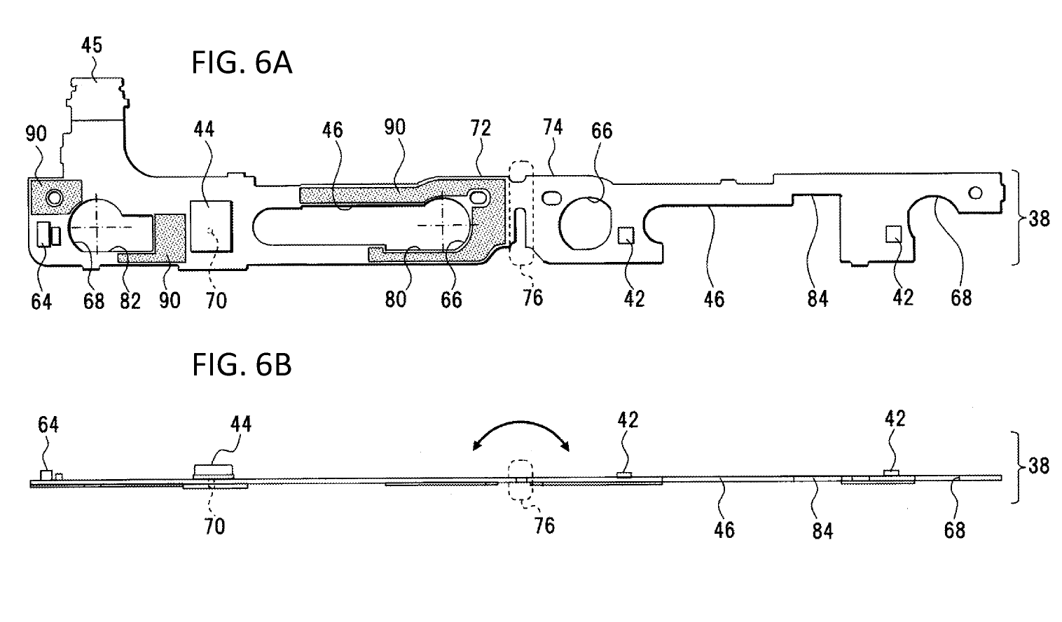

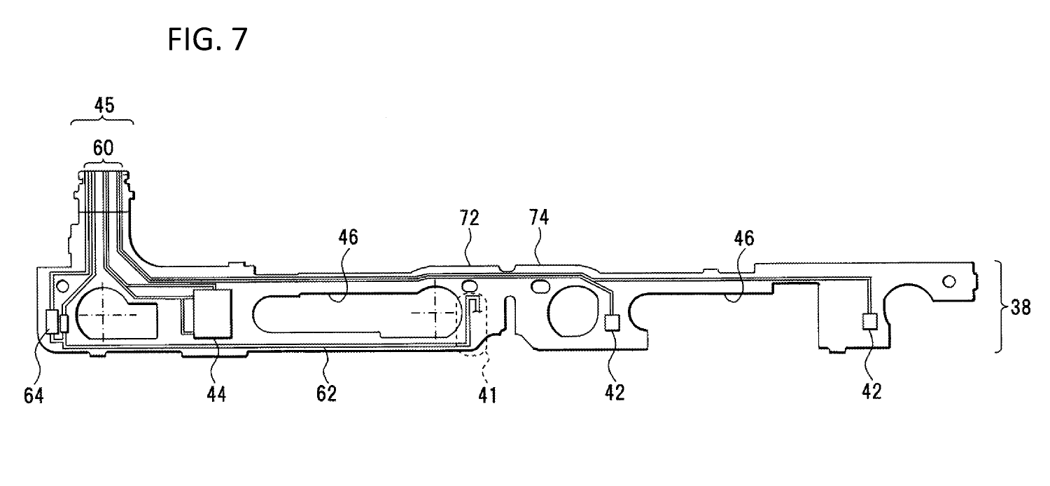

Next, a configuration of the flexible substrate will be described with reference to FIG. 4, FIG. 5, FIG. 6 and FIG. 7. FIG. 4 is a view depicting an example of a mounting configuration of the flexible substrate. FIG. 5 is a view depicting an example of a bent state of the flexible substrate. FIG. 6 is a view depicting an example of a mounting configuration in the state where the flexible substrate is opened. FIG. 7 is a view depicting an example of conductor wirings in the state where the flexible substrate is opened. The configuration depicted in FIG. 4 to FIG. 7 is an example, and the present invention is not limited to this.

On the flexible substrate 38, a circuit wiring 60 electrically connected to the LED element 42, the microphone 44, and the like, which are mounted on the flexible substrate 38, is installed, and also an antenna pattern 62, such as an FM transmitter, is formed as the antenna 41. The circuit wiring 60 and the antenna pattern 62 are arranged from the side of the connector 45.

The antenna pattern 62 is connected to, for example, an antenna matching component 64 mounted on the rear surface side of the flexible substrate 38, and is arranged toward the left and right ends of the flexible substrate 38. The antenna matching component 64 is an example of a functional component for electrically connecting the antenna pattern 62 to, for example, a feeding section, and the like, which is mounted in the substrate section 12.

Through holes 66 and 68 are formed in the flexible substrate 38. For example, the through hole 35 of the substrate section 12 is arranged on the inner side of each of the through holes 66 and 68, and a fixing component is made to pass through the through hole 35 and each of the through holes 66 and 68. Further, a sound absorbing hole 70 is formed through the flexible substrate 38 from a rear surface side position corresponding to the mounting position of the microphone 44 on the flexible substrate 38, so as to guide, to the microphone 44, sound/voice taken from the sound absorbing hole 18 of the movable front case 8.

As shown in FIG. 5A, the flexible substrate 38 is configured, for example, by stacking a first substrate 72 arranged on the front surface side, on a second substrate 74 arranged on the rear surface side. As shown in FIG. 5B, for example, the longitudinal one end side of the first substrate 72 is set as a bending section 76, and the flexible substrate 38 is bent at the bending section 76. For example, the microphone 44 and the antenna matching component 64 are mounted on the first substrate 72, and when the first substrate 72 is folded at the bending section 76, the microphone 44 and the antenna matching component 64 are arranged toward the rear surface side of the flexible substrate 38. In this state, as described above, the microphone 44 can receives sound/voice, and the like, through the sound absorbing hole 70 formed on the front surface side of the flexible substrate 38.

Further, for example, the LED elements 42, and the like, are mounted on the second substrate 74, and when the second substrate 74 is stacked on the first substrate 72, the mounting components of the LED elements 42, and the like, are arranged on the front surface side of the substrate section 38. The flexible substrate 38, which is configured by the first substrate 72 and the second substrate 74, is bent at the bending section 76 so that the component-mounting surface sides of the first substrate 72 and the second substrate 74 are overlapped with each other.

A part of each of the first substrate 72 and the second substrate 74 is opened in order to avoid that one of the substrates 72 and 74 stacked together is brought into contact with the component mounted on the other opposite substrate. In the first substrate 72, opening sections 80 and 82 are formed at positions respectively facing the LED elements 42 mounted on the second substrate 74. The opening section 80 is opened, for example, between the through hole 66 and the opening section 46, so as to connect the through hole 66 to the opening section 46. Further, the opening section 82 is formed adjacent to the through hole 68, so as to be connected to the one side of the through hole 68.

When the opening sections 80 and 82 are formed in the first substrate 72, the LED elements 42 mounted on the second substrate 74 can be exposed to the front surface side of the flexible substrate 38 as shown in FIG. 5A, and are enabled to emit light, for example, on the peripheral side of the display window section 14 of the portable telephone 2.

In the second substrate 74, for example, a cutout section 84 is formed in a part of the substrate so as to correspond to the mounting position of the microphone 44 mounted on the first substrate 72.

In this state, when the first substrate 72 is stacked on the second substrate 74, the microphone 44 is arranged at the cutout section 84, so as to be exposed to the rear surface side of the flexible substrate 38. Further, for example, on one end side of the second substrate 74, a cutout section 86 is formed at a position facing the antenna matching component 64 mounted on the first substrate 72, so as to avoid contact between the antenna matching component 64 and the second substrate 74.

Note that the other functional component may also be mounted on one of the first substrate 72 and the second substrate 74. In this case, a part of the other substrate facing the substrate with the other functional component mounted thereon may be formed to have a cutout or an opening at a position corresponding to the mounting position of the functional component.

As shown in FIG. 6, the first substrate 72 and the second substrate 74 are connected to each other so as to configure, for example, a piece of flexible substrate or a piece formed of a plurality of flexible substrates, and the length of the longitudinal side of the piece is set longer than the length of the substrate section 12 of the portable telephone 2. Further, when the flexible substrate 38 is connected to the substrate section 12, the flexible substrate 38 is bent at the bending section 76 which is set so that the flexible substrate 38 is bent to a length that can be housed in the space section 39 (FIG. 3) of the first housing section 4. In this case, the length of the longitudinal side of the first substrate 72 and the second substrate 74 is set to be equal to each other or to be different from each other.

On the flexible substrate 38 depicted in FIG. 6A, for example, an adhesive member 90 is attached to a part on the mounting surface side of the first substrate 72. The adhesive member 90 is attached to a part of or the whole of the portion of the first substrate 72, which portion is brought into contact with the second substrate 74 by the bending of the flexible substrate 38.

As shown in FIG. 6B, in the opened state of the first substrate 72 and the second substrate 74 of the flexible substrate 38, the functional components are mounted on the surfaces of the first substrate 72 and the second substrate 74, which surfaces are located on the same side. The functional components are respectively mounted, for example, at positions having different distances from the bending section 76 of the flexible substrate 38, and the distances are set so that, even when the first substrate 72 and the second substrate 74 are stacked together, the functional components are prevented from being brought into contact with each other.

That is, when the first substrate 72 and the second substrate 74 are stacked together, the functional component mounting surfaces of the first substrate 72 and the second substrate 74 are arranged on the inner side of the flexible substrate 38, so that, as described above, only the mounted components or parts of the substrate together with the components are exposed to the outer surface side of the flexible substrate 38.

As shown in FIG. 7, the circuit wiring 60 is connected to, for example, the LED elements 42, the microphone 44, and the like, which are the functional components mounted on the flexible substrate 38, and transmission and reception of data, and the like, are performed between the functional components and the side of the substrate section 12 via the connector 45. In the circuit wiring 60, for example, one or a plurality of wiring lines are connected to each of the functional components mounted on the flexible substrate 38, and the number of wiring lines of the circuit wiring 60 is changed according to the number of the components mounted on the flexible substrate 38.

The circuit wiring 60 is arranged so as to be connected to the LED elements 42 mounted on the second substrate 74 via the bending section 76. That is, the circuit wiring 60 is configured so as to be able to be bent at the bending section 76.

In this way, in the case where many functional components are mounted, when a long wiring substrate is used, an increase in the density of the circuit wiring can be prevented, and the area, in which the functional components can be mounted, can be increased. That is, even when mounting components are arranged so as to be close to each other, the routing of the circuit wiring 60 on the flexible substrate can be prevented from becoming complicated.

Further, as described above, in the antenna 41 formed on the flexible substrate 38, the antenna pattern 62 is formed toward the side of the bending section 76 via the antenna matching component 64 mounted on the first substrate 72. The antenna pattern 62 is installed in a linear shape having a predetermined length according to the antenna length (electric length) corresponding to, for example, the wavelength of a signal used for communication.

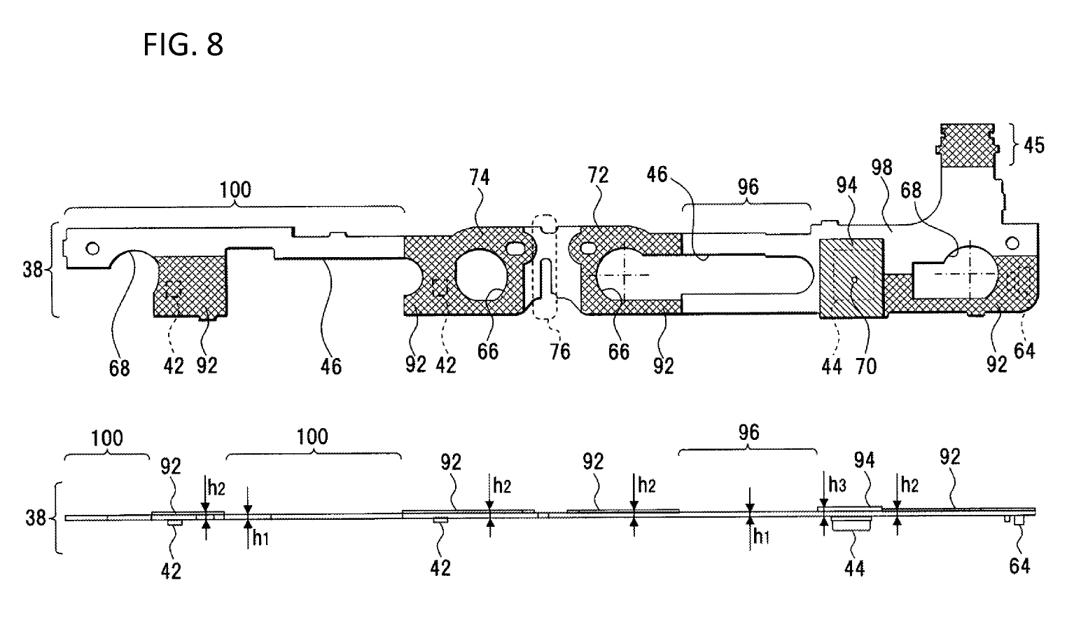

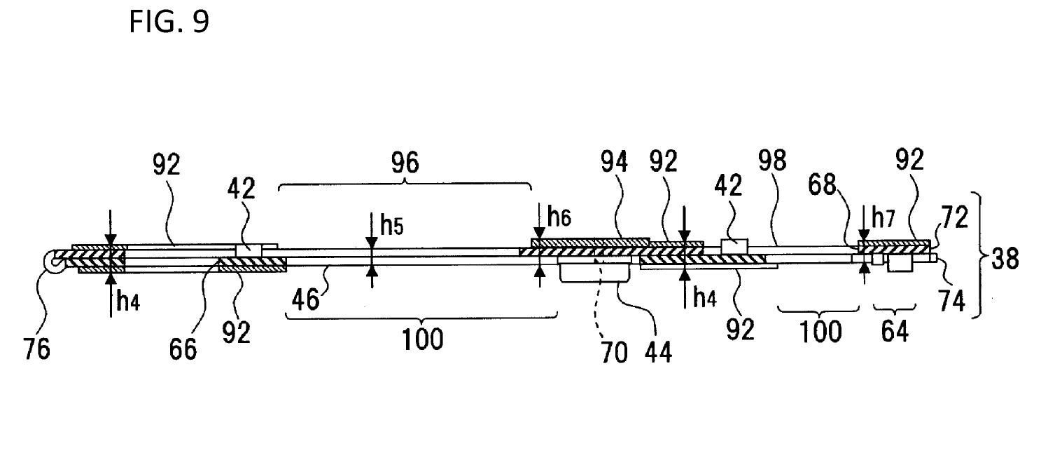

Next, a configuration on the rear surface side and the thickness of the first and second substrates will be described with reference to FIG. 8 and FIG. 9. FIG. 8 is a view depicting an installation example of reinforcing members on the flexible substrate. FIG. 9 is a view depicting a sectional view taken along line A-A in FIG. 4. The configuration depicted in FIG. 8 and FIG. 9 is an example, and the present invention is not limited to this.

A part of the rear surface side of the component mounting surfaces of the first substrate 72 and the second substrate 74 is reinforced. On the first substrate 72 depicted in FIG. 8A, for example, a first reinforcing member 92 is installed at each of the mounting positions of the connector 45 and the antenna matching component 64, and at the formation position of the antenna pattern 62. Further, a second reinforcing member 94 is installed at the mounting position of the microphone 44. At this time, on the first substrate 72, a substrate section 96 in the periphery of the opening section 46, and a substrate section 98 in the periphery of the through hole 68 are not reinforced.

On the second substrate 74, the first reinforcing member 92 is installed at the mounting position of the LED element 42 and in the periphery of the LED element 42 and the through hole 66. At this time, on the second substrate 74, a substrate section 100 in the periphery of the opening section 46, and in the periphery of the through hole 68 is not reinforced. Further, the reinforcing member is not installed at the bending section 76 at which the flexible substrate 38 is bent so as to make the substrate 72 and the substrate 74 stacked together.

The reinforcing members 92 and 94 are examples of means which prevents the deformation of the flexible substrate by increasing the thickness of the substrates 72 and 74. When the rear surface side at the mounting positions of the functional components is reinforced, it is possible to prevent the exfoliation and breakage of the mounting components due to the deformation of the flexible substrate.

Each of the first reinforcing member 92 and the second reinforcing member 94 is formed of, for example, a resin film member. The second reinforcing member 94 is formed to have a thickness larger than the thickness of the first reinforcing member 92, and has low flexibility. The reinforcing members 92 and 94 are bonded to the substrates 72 and 74 by using, for example, an adhesive, and the like.

The reinforcing members 92 and 94 are installed on the substrates 72 and 74 as depicted in FIG. 8B. For example, the thickness of the portion of the substrate, in which portion the reinforcing members 92 and 94 are not installed, is set as h₁, the thickness of the portion of the substrate, in which portion the first reinforcing member 92 is installed, is set as h₂, and the thickness of the portion of the substrate, in which portion the second reinforcing member 94 is installed, is set as h₃.

When the substrates 72 and 74 are stacked together, the mounting components are arranged as depicted in FIG. 9. As described above, the LED elements 42 mounted on the second substrate 74 are exposed to the front surface side of the flexible substrate 38, and the microphone 44 and the antenna matching component 64, which are mounted on the first substrate 72, are exposed from the second substrate 74 to the rear surface side of the flexible substrate 38.

The thickness of the flexible substrate 38, on which the functional components are mounted, is changed according to the positions at which the reinforcing members 92 and 94 are provided. The thickness of the peripheral portion of the LED element 42 is set to, for example, h₄. The thickness h₄ corresponds to, for example, the thickness of the substrates 72 and 74, and the thickness of two of the first reinforcing members 92, and hence is set as h₄=2h₂. Further, the reinforcing member is not installed in the peripheral portion of the opening section 46, and the thickness of this portion is set to, for example, h₅. The thickness h₅ corresponds to the thickness of the substrates 72 and 74 and hence is set as h₅=2h₁. The thickness of the peripheral portion of the microphone 44 is set to, for example, h₆. The thickness h₆ corresponds to, for example, the thickness of the substrates 72 and 74, and the thickness of the second reinforcing member 94, and hence is set as h₆=h₁+h₃. The thickness of the peripheral portion of the antenna matching component 64 is set to, for example, h₇. The thickness h₇ corresponds to, for example, the thickness of the substrates 72 and 74, and the thickness of the first reinforcing member 92, and hence is set as h₇=h₁+h₂.

In this way, the thickness of the flexible substrate 38 is changed in the range of h₄ to h₇ in each portion on the substrate by changing, for example, the combination of the kinds of the reinforcing members 92 and 94, and of the presence or absence of the reinforcing members 92 and 94, and the like. The thickness of the flexible substrate 38 is set to be changed in this way, and thereby it is possible to avoid, for example, that the depressions and projections in the housing section 4 are brought into contact with the mounting components on the flexible substrate 38 at the time when the flexible substrate 38 is mounted in the housing section 4.

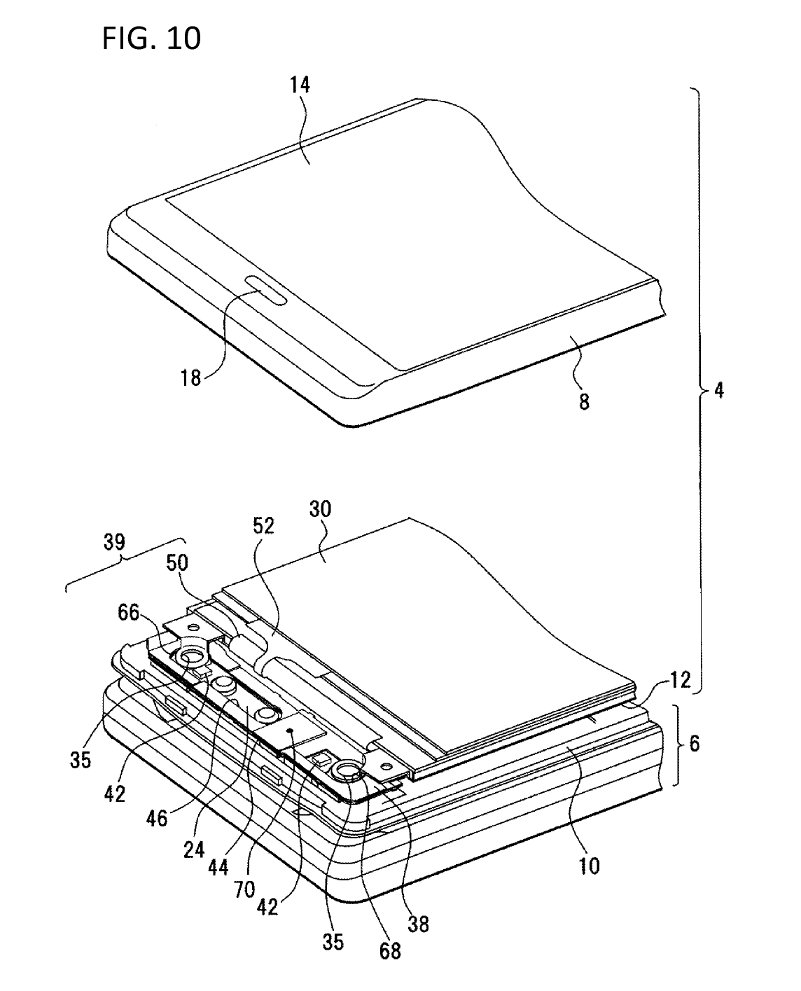

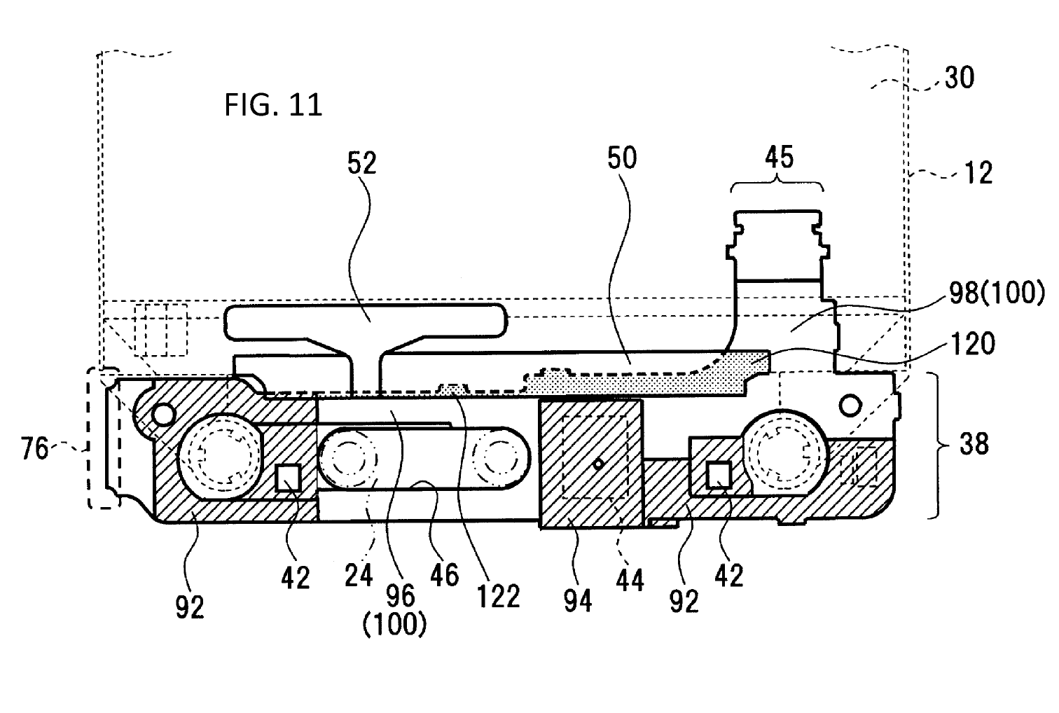

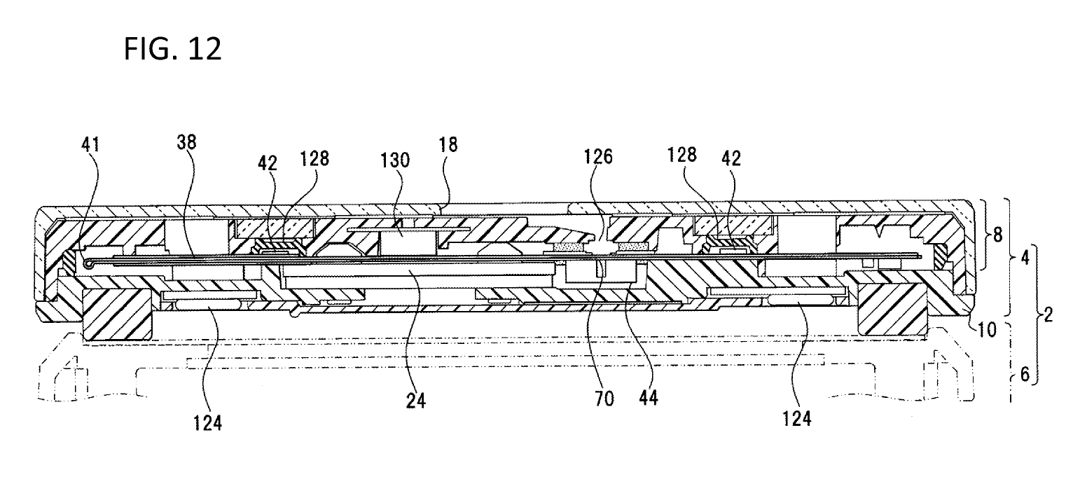

Next, the mounting state of the flexible substrate will be described with reference to FIG. 10, FIG. 11 and FIG. 12. FIG. 10 is a view depicting an example of a state where the flexible substrate is mounted on the side of the movable rear case. FIG. 11 is a view depicting an example of an overlapped state of the flexible substrate and other components. FIG. 12 is a view depicting a sectional view taken along line B-B in FIG. 2. The configuration depicted in FIG. 10 to FIG. 12 is an example, and the present invention is not limited to this.

In the state where the through holes 35 of the substrate section 12 are respectively arranged at the through holes 66 and 68, the flexible substrate 38 mounted in the housing section 4 is fixed, by fixing components (not depicted), to, for example, the sides of the movable rear case 10 and of the movable front case 8 together with the substrate section 12. At this time, the water cut-off component 24 installed on the movable rear case 10 is arranged at the opening section 46 of the flexible substrate 38.

The substrate section 12 is provided with, for example, the flexible cables 50 and 52 which electrically connect the substrate section 12 to the liquid crystal display panel 30. The flexible cables 50 and 52 are arranged on the side of the space section 39 of the housing section 4.

As shown in FIG. 11, on the end side of the substrate section 12, the flexible cables 50 and 52 are arranged at positions overlapping with a part of the flexible substrate 38. Here, there are overlapping portions 120 and 122 between the flexible substrates 38, and the flexible cables 50 and 52. The overlapping portion 120 is formed, for example, on the side of the substrate section 98 of the flexible substrate 38, and the overlapping portion 122 is formed on the side of the substrate section 96.

As described above, the substrate sections 96 and 98 are portions at which the reinforcing members 92 and 94 are not attached onto the substrate. The substrate sections 96 and 98 are made to overlap with the substrate section 100 on the side of the second substrate 74, and thereby are set to have a smallest thickness of h₅. That is, in the flexible substrate 38, the arrangement positions of the reinforcing members 92 and 94 are set in consideration of the case where the flexible substrate 38 is mounted in the housing 4, and hence the thickness of the flexible substrate 38 can be adjusted.

Thereby, it is possible to prevent the flexible substrate 38 from being brought into contact with and interfering with the other functional components installed in the periphery of the flexible substrate 38. Further, the thickness of the flexible substrate 38 is adjusted for each portion of the flexible substrate 38, and thereby the height of the flexible substrate 38 can be set according to the configuration in the periphery of the flexible substrate 38 mounted in the housing 4.

In the housing section 4 depicted in FIG. 12, the movable front case 8 and the movable rear case 10 are joined together so as to be fixed to each other by fixing means 124. The flexible substrate 12 is arranged so that, for example, the sound absorbing hole 70 of the microphone 44 corresponds to an opening section 126 formed in the inside of the movable front case 8. Further, each of the LED elements 42 mounted on the flexible substrate 38 is arranged so as to correspond to, for example, a transparent water cut-off component 128 which functions as an illuminating section. At this time, the thickness of the flexible substrate 38 is changed by the presence or absence of the reinforcing members 92 and 94 (FIG. 9) as described above, and thereby the flexible substrate 38 is prevented from being brought into contact with or interfering with, for example, other functional components 130 and the water cut-off component 128, and the like, which are installed on the side of the movable front case 8.

Further, each of the reinforcing members 92 and 94 functions as a spacer which adjusts the mounting height of the flexible substrate 38 in the housing section 4. For example, by the combination of the reinforcing members 92 and 94, the thickness of the portion, at which the flexible substrate 38 is brought into contact with the movable rear case 10, is made different from the thickness of the component mounting portion, and thereby the installation position of the flexible substrate 38 can be prevented from being changed in the housing section 4.

In such configuration, the component mounting portion is formed on either or both the front and rear surface sides of the flexible substrate installed in the housing, and thereby it is possible to further mount components together with the antenna pattern and the microphone. Further, the mounting enabling portion can be increased in the conventional arrangement space, and hence multiple functions can be realized in the electronic apparatus while the size of the electronic apparatus is maintained to be small. The opening section and the cutout section are formed in the flexible substrate, and thereby the flexible substrate is prevented from being brought into contact with and interfering with the other functional components arranged in the portable telephone, so that the operation of the functional components can be normally performed. Further, the thickness of the flexible substrate is adjusted by the reinforcing members, and thereby the waste of space in the height direction can be eliminated so as to contribute to the thinning of the portable telephone.

Here, the feature items and advantages according to the first embodiment are listed as follows.

(1) With the flexible substrate arranged on the bottom side of the movable side housing of the portable electronic apparatus, it is possible that the microphone is mounted on the flexible substrate, and also the antenna pattern, such as an FM transmitter, is formed on the flexible substrate, and that the other components, such as an LED, are also mounted on the flexible substrate.

(2) The flexible substrate has a double-fold structure in which components mounted on the flexible substrate are arranged at predetermined positions, for example, by folding the flexible substrate in an overlapping manner.

(3) With the flexible substrate, the microphone and the antenna pattern are mounted on the flexible substrate, and further the LED, and the like, can be mounted on both sides of the flexible substrate, as a result of which, for example, an illumination structure can also be arranged in the space at the lower side of the display section. Further, in the configuration according to the present invention, when a flexible substrate with components mounted on one surface thereof is bent, the substrate becomes a mounted state on both sides, and hence the configuration according to the present invention is advantageous in terms of cost as compared with the case where the mounting is applied to both sides of the flexible substrate.

### Other Embodiments

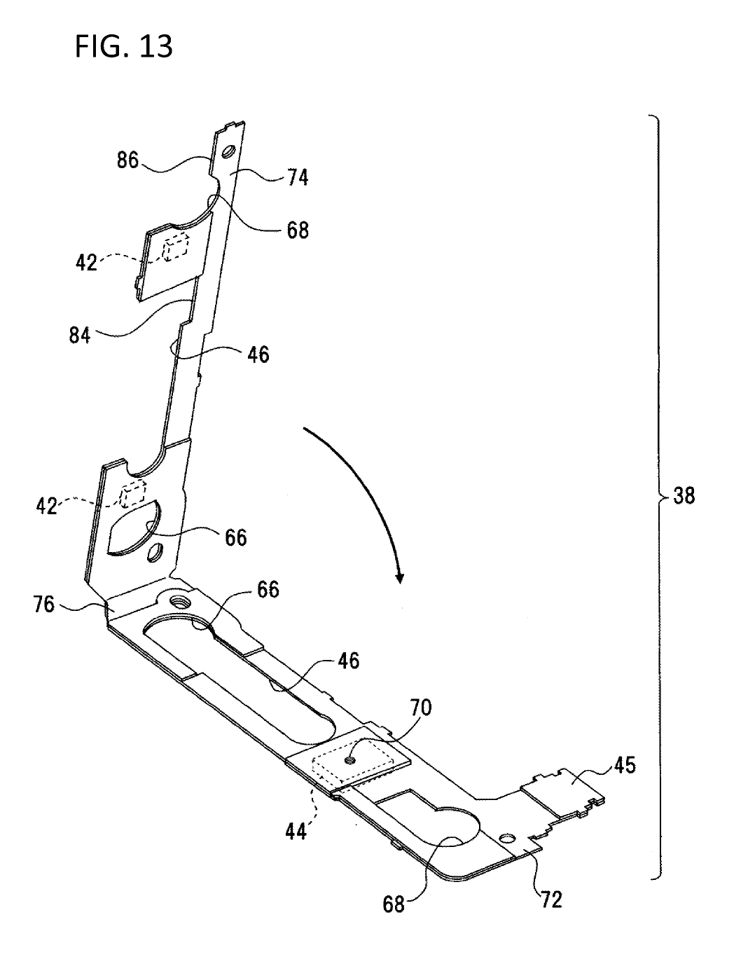

(1) In the above-described embodiment, as for the bending direction of the flexible substrate, a case is exemplified in which the mounting surface of the first substrate 72 and the mounting surface of the second substrate 74 are joined to each other, but the present invention is not limited to this. For example, as shown in FIG. 13, the flexible substrate may also be bent so that the surface of the first substrate 72, on which surface components are not mounted, overlaps with the surface of the second substrate 74, on which surface components are not mounted. In this case, for example, the LED elements 42 are arranged on the front surface side of the flexible substrate 38, and the microphone 44 is arranged on the rear surface side of the flexible substrate 38. At this time, the second substrate 74 is stacked on the first substrate 72 so that the overlapping of the second substrate 74 with the rear surface side of the microphone 44 is avoided by the cutout section 84, and hence the sound absorption by the microphone is not hindered. With such configuration, the same effect as that in the above-described embodiment is obtained.

(2) In the above-described embodiment, a configuration, in which the side of the substrate sections 96 and 98 as a part of the flexible substrate is not reinforced, is exemplified, but the present invention is not limited to this. For example, portions other than the bending section of the flexible substrate may be reinforced. For example, all the portions of the flexible substrate mounted in the housing section, the portions not being brought into contact with or not interfering with the other mounting components, may be reinforced.

(3) In the above-described embodiment, the flexible substrate is bent so that the first substrate and the second substrate overlap with each other, but the present invention is not limited to this. For example, a plurality of independent substrates may be bonded so as to be stuck together.

Next, the following additional descriptions are disclosed about the embodiments described above. The present invention is not limited to the following additional descriptions.

As described above, preferred embodiments, and the like, of the electronic apparatus and the flexible substrate, are described, but the present invention is not limited to those described above. Based on the scope of the invention as described in the appended claims or as disclosed in the embodiments for carrying out the present invention, it is obvious to those skilled in the art that various modifications and changes are possible. It goes without saying that such modifications and changes are also included within the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic apparatus comprising:
a housing having a liquid crystal display section mounted in the housing;
a space section formed between an end side in the housing and the liquid crystal display section; and
a circuit unit having an antenna pattern, a microphone, and one or plurality of mounting components being mounted on one or both of the front and rear surface sides of the circuit unit arranged in the space section.

2. The electronic apparatus according to claim 1, wherein:
the circuit unit includes one or more planar wiring conductors,
the microphone and the mounting component are mounted on one of a surface of the planar wiring conductors, and
one of the planar wiring conductors is folded or the planar wiring conductors overlapped.

3. The electronic apparatus according to claim 1, wherein the microphone is mounted over the rear surface side of the flexible basis of the circuit unit, and wherein at the mounting position of the microphone, a sound absorbing hole for receiving sound/voice is formed from the front surface side of the flexible basis.

4. The electronic apparatus according to claim 1, wherein one or both of an opening section and a cutout section are formed in a flexible basis of the circuit unit so as to expose, to the front surface side of the flexible basis, the microphone or the mounting component that are mounted on the rear surface side of the flexible basis.

5. The electronic apparatus according to claim 1, further comprising a reinforcing section which covers a part of or the whole of the circuit unit.

6. The electronic apparatus according to claim 1, wherein the circuit unit is configured to include a flexible basis.

7. The electronic apparatus according to claim 2, wherein the circuit unit is configured such that a mounting surface of the planar wiring conductors on which the microphone and the mounting component are mounted, or the rear surface of the mounting surface of the planar wiring conductors is folded in an overlapping manner.

8. The electronic apparatus according to claim 1, wherein the mounting component includes at least light emitting device.

9. A flexible substrate comprising:
a wiring conductor configured to form an antenna pattern;
a microphone formed and mounted over the wiring conductor; and
one or plurality of mounting components mounted on one or both of the front and rear surface sides of the wiring conductor, wherein the wiring conductor is folded or superposed.
